(19) United States
(12) Patent Application Publication
(10) Pub. No.: US 2018/0330437 A1
(43) Pub. Date: Nov. 15, 2018

(54) SYSTEM AND METHOD FOR ONLINE EVALUATION AND UNDERWRITING OF LOAN PRODUCTS

(71) Applicant: Syml Systems Inc., Calgary (CA)

(72) Inventors: Kendall RAESSLER, Calgary (CA); Guy PALLISTER, Calgary (CA)

(21) Appl. No.: 16/041,217

(22) Filed: Jul. 20, 2018

Related U.S. Application Data
(63) Continuation of application No. 14/819,887, filed on Aug. 6, 2015.
(60) Provisional application No. 62/034,744, filed on Aug. 7, 2014.

(51) Int. Cl. G06Q 40/02

(52) U.S. Cl. CPC G06Q 40/025

(57) ABSTRACT

There is disclosed a system and method for online evaluation and underwriting of loan products. In an embodiment, the system has an adaptive finance application for posing questions designed to elicit responses indicative of financial and risk attributes for the client, wherein the content of each successive question of the set of questions depends upon prior responses to previous questions, such that a detailed client profile is generated from the responses; a multi-lender algorithmic underwriting application for comparing matching criteria derived from the detailed client profile against a database of loan products with underwriting requirements available from multiple lending institutions, and identifying loan products matching the detailed client profile; and an output for outputting loan products with underwriting requirements having a close match to the detailed client profile.

### CROSS-REFERENCE TO RELATED APPLICATIONS

This application is a continuation of U.S. patent application Ser. No. 14/819,887, filed on Aug. 6, 2015, which claims the benefit of U.S. Provisional Patent Application Ser. No. 62/034,744, filed Aug. 7, 2014, the content of each of which is incorporated herein by reference in its entirety.

### FIELD

The present disclosure relates to a system and method for online evaluation and underwriting of loan products.

### BACKGROUND

In the prior art, borrowers or users of loan products often have had a limited ability to evaluate borrowing alternatives, typically being limited to comparing posted interest rates of a few lending institutions that may be familiar to them. In order to compare these alternatives, borrowers must often go through an application process by filling out loan application forms with each lending institution, which can be very time consuming. Lenders are also limited by the amount of information available from a borrower, which may limit them from offering their loan products to otherwise qualified borrowers based on lack of information. This can significantly limit the number of options available to a borrower, and also limit the ability of lending institutions to provide loan products to qualified borrowers.

Therefore, what is needed is an improved system and method for evaluation and underwriting of loan products which overcomes at least some of the limitations identified above.

### SUMMARY

The present disclosure relates to a system and method for online evaluation and underwriting of loan products by creating a detailed client profile for a borrower or user of loan products, and matching the detailed client profile with the best loan products available from a plurality of lending institutions.

In an aspect, the system and method is adapted to receive responses to adaptive questions posed to explore and assess the financial profile and needs of the borrower. These inputs are used to create a detailed client profile, including the borrower's financial information, risk preferences, and short-term and longer term goals. The system and method also maintains an up-to-date database comprising potentially dozens, hundreds or even thousands of available loan products and their underwriting requirements from multiple lending institutions, and the detailed client profile is run against the loan products database for potential matches.

In an embodiment, the potential matches are ranked based on the degree to which the client profile matches the loan products and their underwriting requirements, and a report is generated to recommend the closest matches as possible borrowing options for the borrower to consider.

In another embodiment, the system and method reviews the potential matches and generates a recommendation for utilizing multiple blended loan products at the same time, if appropriate to optimize borrowing costs or flexibility, based on the detailed client profile.

In another embodiment, the system and method allows generation of alternative “what-if” scenarios, if the user selects one loan product over another, or changes a key parameter in the detailed user profile based on evolving preferences.

In another embodiment, the system and method is adapted to maintain and update the detailed client profile, and periodically re-evaluate the recommended loan products to determine if the loan products are still optimal. This allows the system and method to identify and recommend better loan products that may become available, which may make it advantageous for the borrower to renegotiate a loan, and/or enter into a shorter or longer fixed-term.

Advantageously, by creating and maintaining a detailed client profile for the borrower, and periodically running the detailed client profile against an up-to-date database of potentially hundreds or even thousands of available loan products, the system and method is able to recommend optimal borrowing options that are tailored to the borrower's needs at any point in time.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 shows a schematic block diagram of an illustrative computer system architecture in accordance with an embodiment.

FIG. 2 shows a schematic diagram of a server that is configured to execute methods in accordance with the present technology.

FIGS. 3(a) to 3(t) show illustrative examples of an Adaptive Finance Application in accordance with an embodiment.

FIGS. 4(a) to 4(i) show illustrative examples of CRM integration in accordance with an illustrative embodiment.

FIGS. 5(a) to 5(d) show an illustrative example of a finance summary resulting from the system evaluation in accordance with an illustrative embodiment.

### DETAILED DESCRIPTION

As noted above, the present disclosure relates to a system and method for online evaluation and underwriting of loan products, in order to identify qualified borrowers, and match these qualified borrowers with the best borrowing options available from a plurality of loan products offered by multiple lending institutions.

In an aspect, the system and method is adapted to receive responses to adaptive questions posed to explore and assess the financial profile and needs of the borrower. These inputs are used to create a detailed client profile, including the borrower's financial information, risk preferences, and short-term and longer term goals. The system and method also maintains an up-to-date database comprising potentially dozens, hundreds or even thousands of available loan products and their underwriting requirements from multiple lending institutions, and the detailed client profile is run against the loan products database for potential matches.

In an embodiment, the potential matches are ranked based on the degree to which the client profile matches the loan products and their underwriting requirements, and a report is generated to recommend the closest matches as possible borrowing options for the borrower to consider when purchasing major items. Examples of such purchases include but are not limited to homes, vehicles (including automobiles, recreational vehicles, and boats), and education.

In another embodiment, the system and method reviews the potential matches and generates a recommendation for utilizing multiple blended loan products at the same time, if appropriate to optimize borrowing costs or flexibility, based on the detailed client profile.

In another embodiment, the system and method allows generation of alternative “what-if” scenarios, if the user selects one loan product over another, or changes a key parameter in the detailed user profile based on evolving preferences.

In another embodiment, the system and method is adapted to maintain and update the detailed client profile, and periodically re-evaluate the recommended loan products to determine if the loan products are still optimal. This allows the system and method to identify and recommend better loan products that may become available, which may make it advantageous for the borrower to renegotiate a loan, and/or enter into a shorter or longer fixed-term.

Advantageously, by creating and maintaining a detailed client profile for the borrower, and periodically running the detailed client profile against an up-to-date database of potentially hundreds or even thousands of available loan products, the system and method is able to recommend optimal borrowing options that are tailored to the borrower's needs at any point in time.

Illustrative embodiments of the present invention will now be described in more detail with reference to the drawings.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the present technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

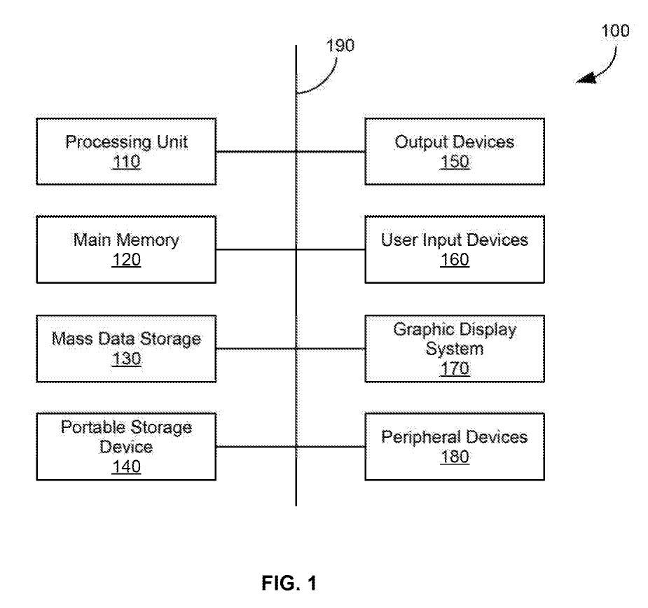

FIG. 1 illustrates an exemplary computer system 100 that may provide a suitable environment or platform to implement some embodiments of the present invention. The computer system 100 of FIG. 1 may be implemented in the contexts of the likes of computing systems, networks, servers, or combinations thereof. The computer system 100 of FIG. 1 includes one or more processor units 110 and main memory 120. Main memory 120 stores, in part, instructions and data for execution by processor units 110. Main memory 120 stores the executable code when in operation, in this example. The computer system 100 of FIG. 1 further includes a mass data storage 130, portable storage device 140, output devices 150, user input devices 160, a graphics display system 170, and peripheral devices 180.

The components shown in FIG. 1 are depicted as being connected via a single bus 190. The components may be connected through one or more data transport means. Processor unit 110 and main memory 120 is connected via a local microprocessor bus, and the mass data storage 130, peripheral device(s) 180, portable storage device 140, and graphics display system 170 are connected via one or more input/output (I/O) buses.

Mass data storage 130, which can be implemented with a magnetic disk drive, solid state drive, or an optical disk drive, is a non-volatile storage device for storing data and instructions for use by processor unit 110. Mass data storage 130 stores the system software for implementing embodiments of the present disclosure for purposes of loading that software into main memory 120.

Portable storage device 140 operates in conjunction with a portable non-volatile storage medium, such as a flash drive, floppy disk, compact disk, digital video disc, or Universal Serial Bus (USB) storage device, to input and output data and code to and from the computer system 100 of FIG. 1. The system software for implementing embodiments of the present disclosure is stored on such a portable medium and input to the computer system 100 via the portable storage device 140.

User input devices 160 can provide a portion of a user interface. User input devices 160 may include one or more microphones, an alphanumeric keypad, such as a keyboard, for inputting alphanumeric and other information, or a pointing device, such as a mouse, a trackball, stylus, or cursor direction keys. User input devices 160 can also include a touchscreen. Additionally, the computer system 100 as shown in FIG. 1 includes output devices 150. Suitable output devices 150 include speakers, printers, network interfaces, and monitors.

Graphics display system 170 include a liquid crystal display (LCD) or other suitable display device. Graphics display system 170 is configurable to receive textual and graphical information and processes the information for output to the display device.

Peripheral devices 180 may include any type of computer support device to add additional functionality to the computer system.

The components provided in the computer system 100 of FIG. 1 are those typically found in computer systems that may be suitable for use with embodiments of the present disclosure and are intended to represent a broad category of such computer components that are well known in the art. Thus, the computer system 100 of FIG. 1 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, the computing system 100 may be implemented as a cloud-based computing environment, such as a virtual machine operating within a computing cloud. In other embodiments, the computing system 100 may itself include a cloud-based computing environment, where the functionalities of the computing system 100 are executed in a distributed fashion. Thus, the computing system 100, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

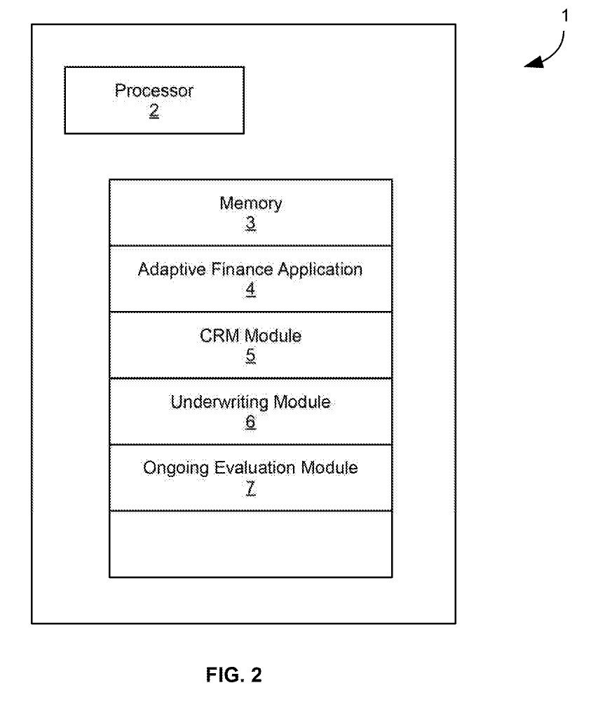

FIG. 2 is a schematic diagram of a server 1 that is configured to execute methods in accordance with the present technology. In some embodiments, the server 1 can be configured as a cloud computing environment. In general, a cloud-based computing environment is a resource that typically combines the computational power of a large grouping of processors and/or that combines the storage capacity of a large grouping of computer memories or storage devices. For example, systems that provide a cloud resource may be utilized exclusively by their owners, such as Google™ or AWS™; or such systems may be accessible to outside users who deploy applications within the computing infrastructure to obtain the benefit of large computational or storage resources.

The cloud may be formed, for example, by a network of web servers such as server 1 with each web server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depend on the type of business associated with the user.

In some embodiments, the server 1 comprises a processor 2 and memory 3. The memory 3 stores various applications, engines, modules, and algorithms, which are all described in greater detail below. In some embodiments, the memory comprises an Adaptive Finance Application 4, a CRM module 5, an underwriting module 6, an ongoing evaluation module 7.

As used herein, the terms “module” and/or “engine” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality.

A) Adaptive Finance Application

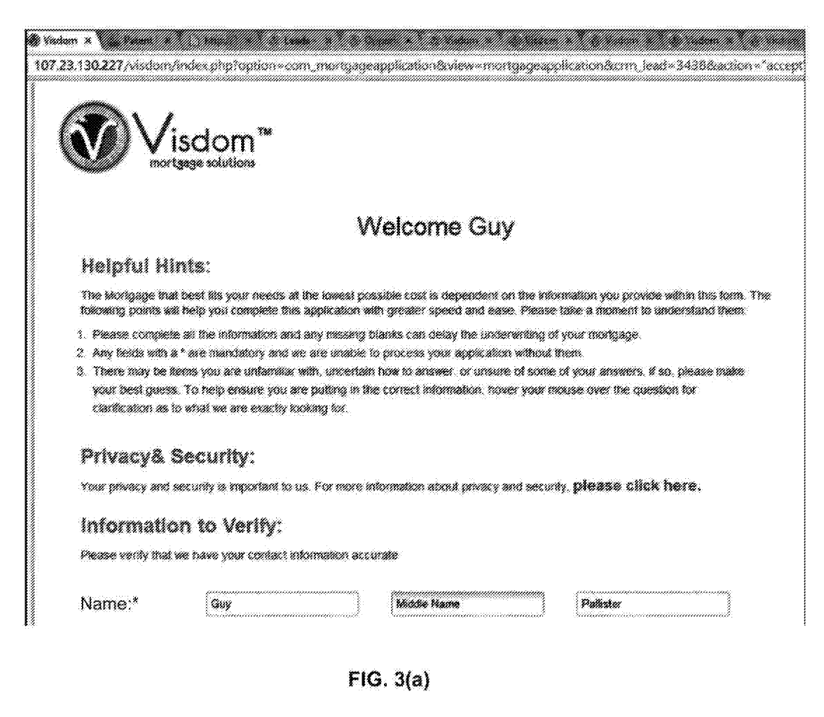

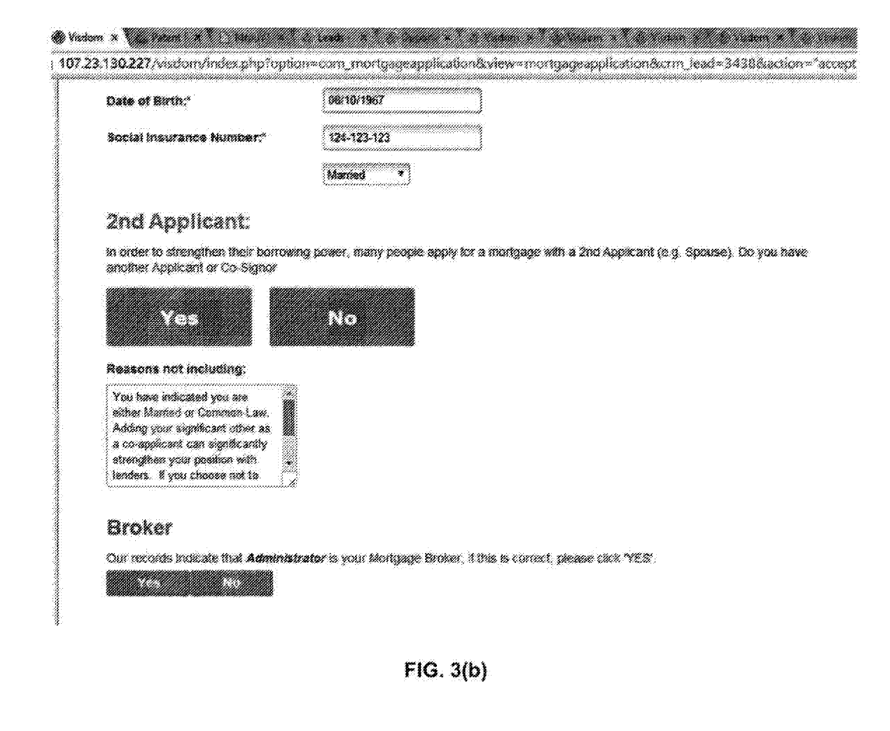

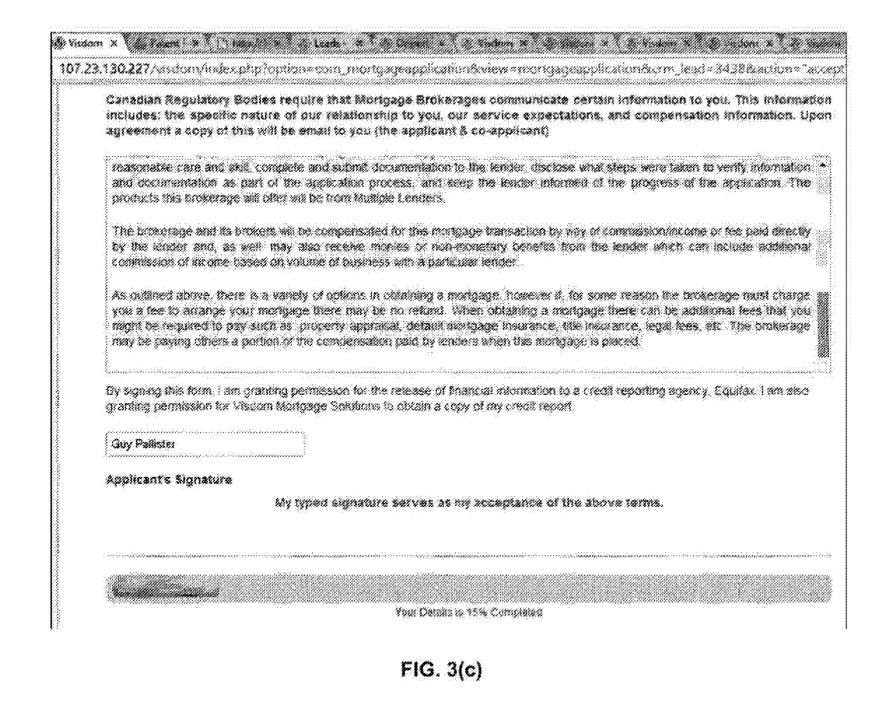

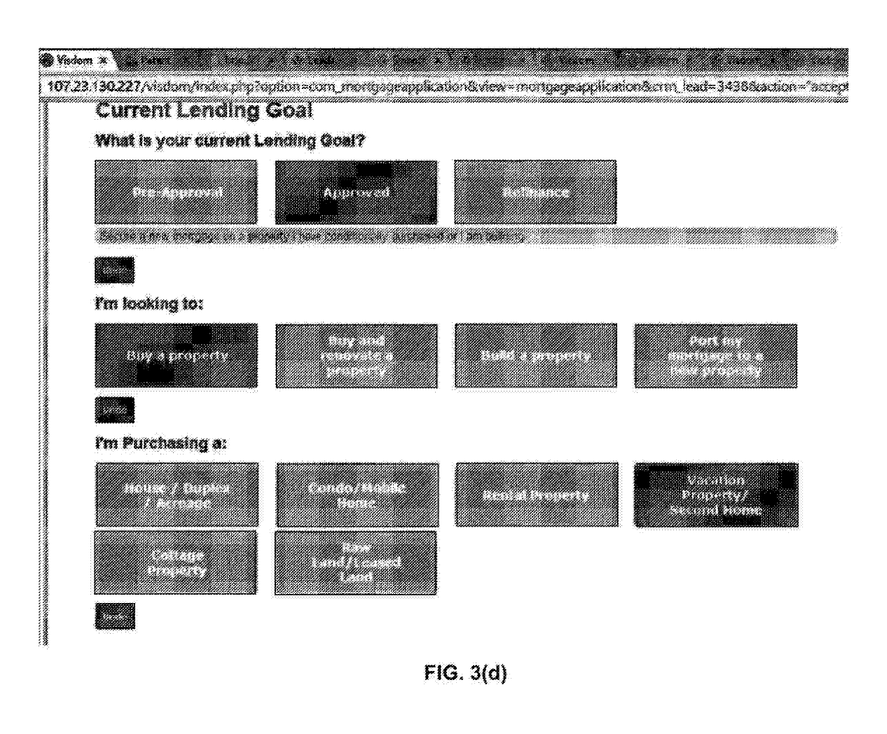

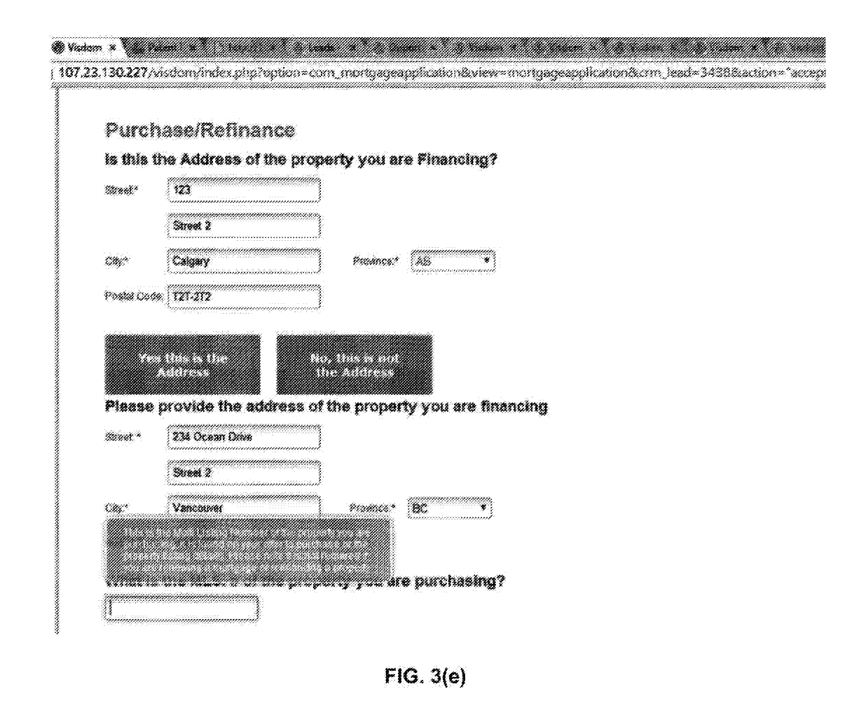

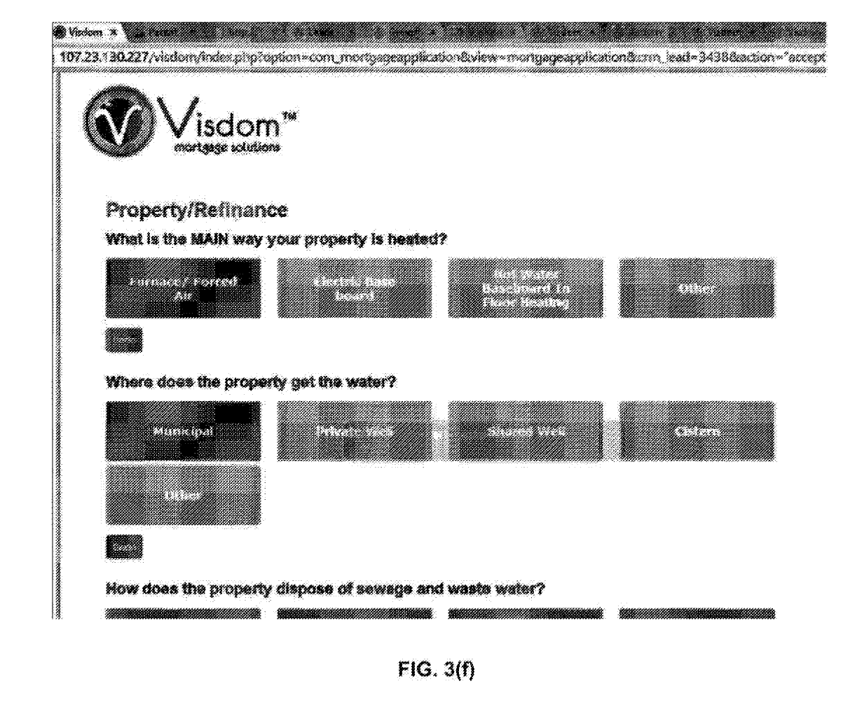

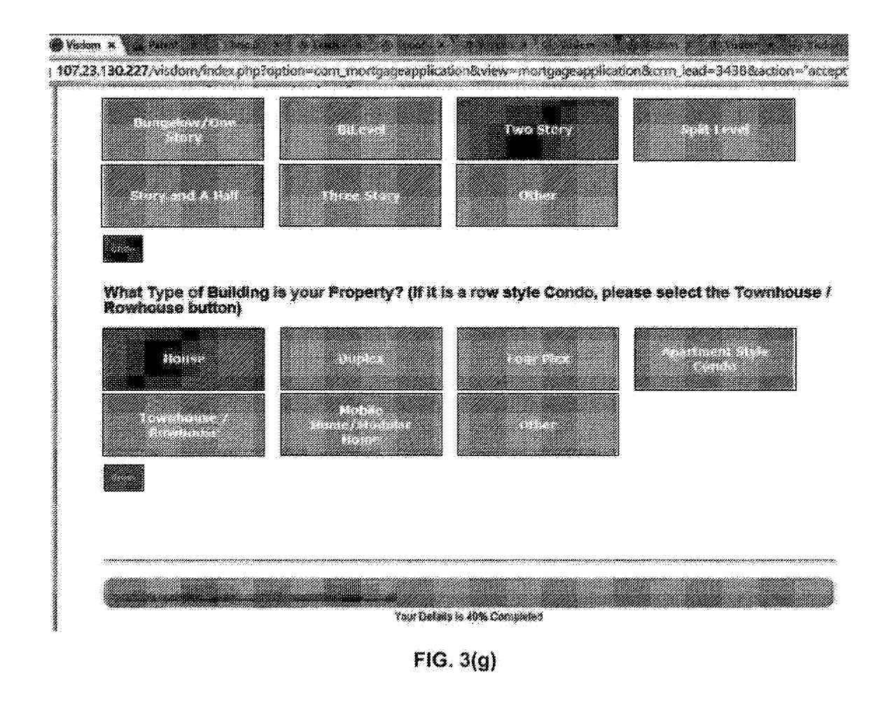

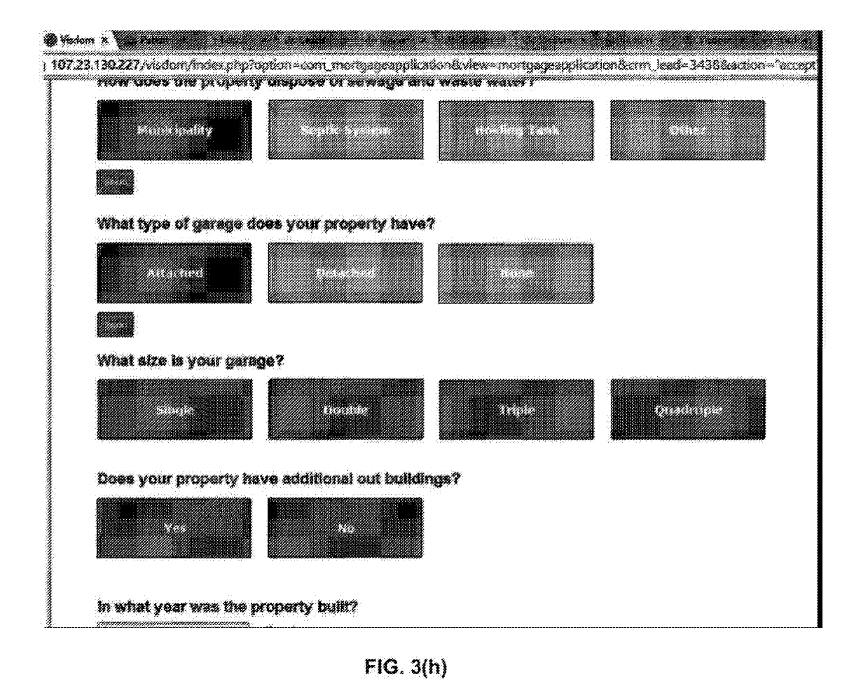

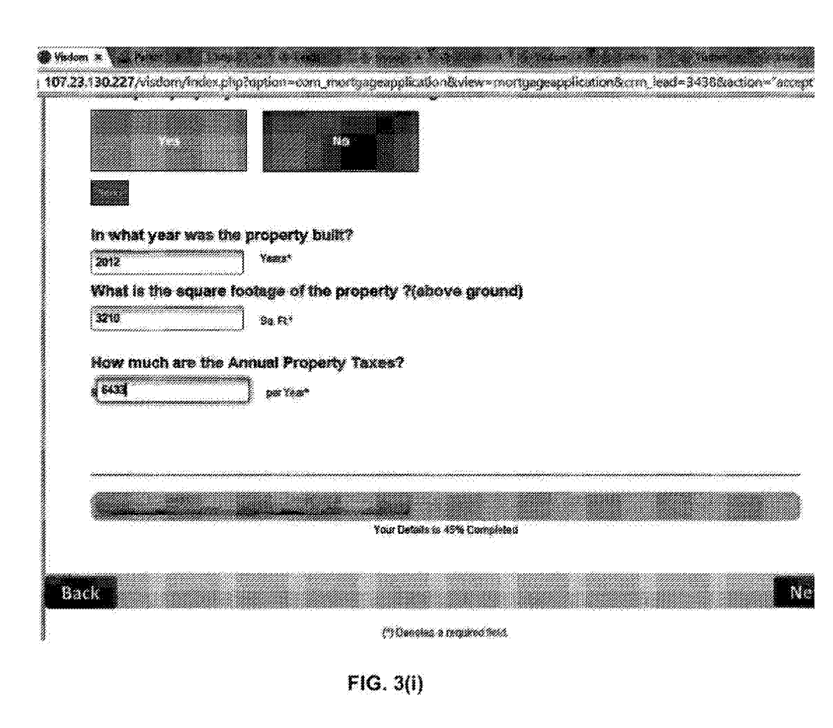

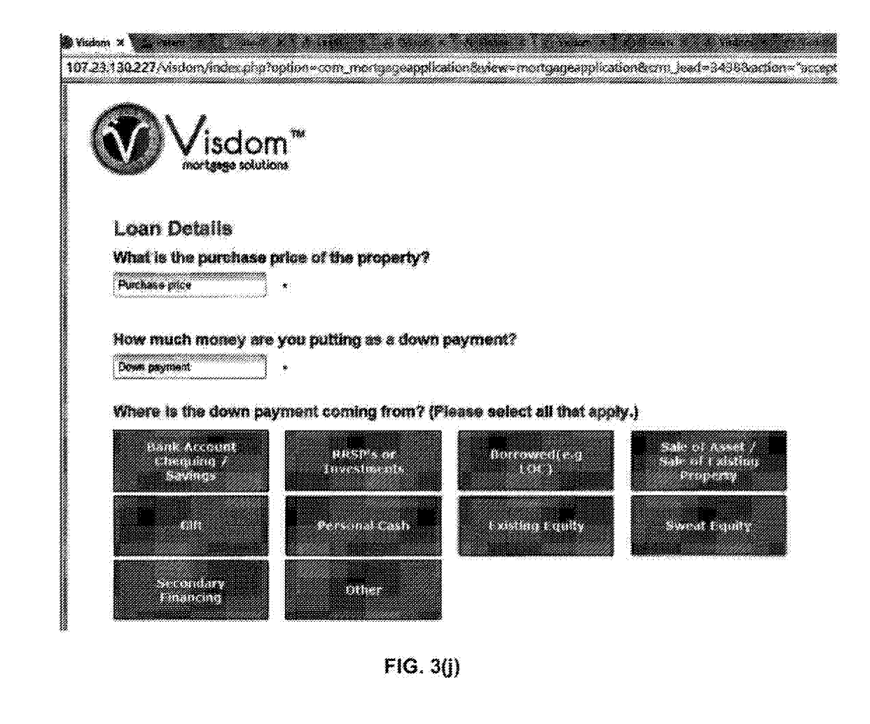

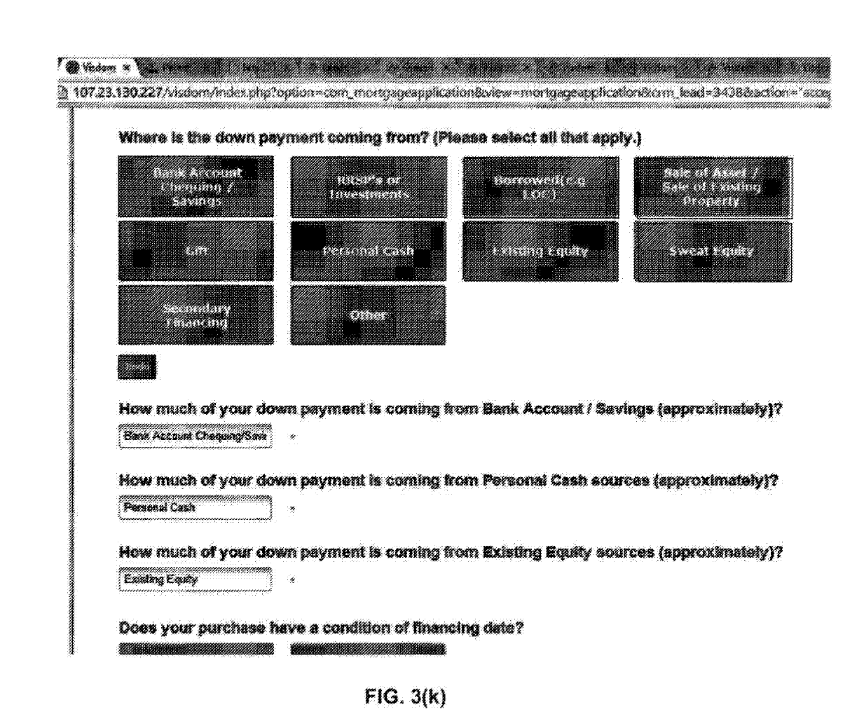

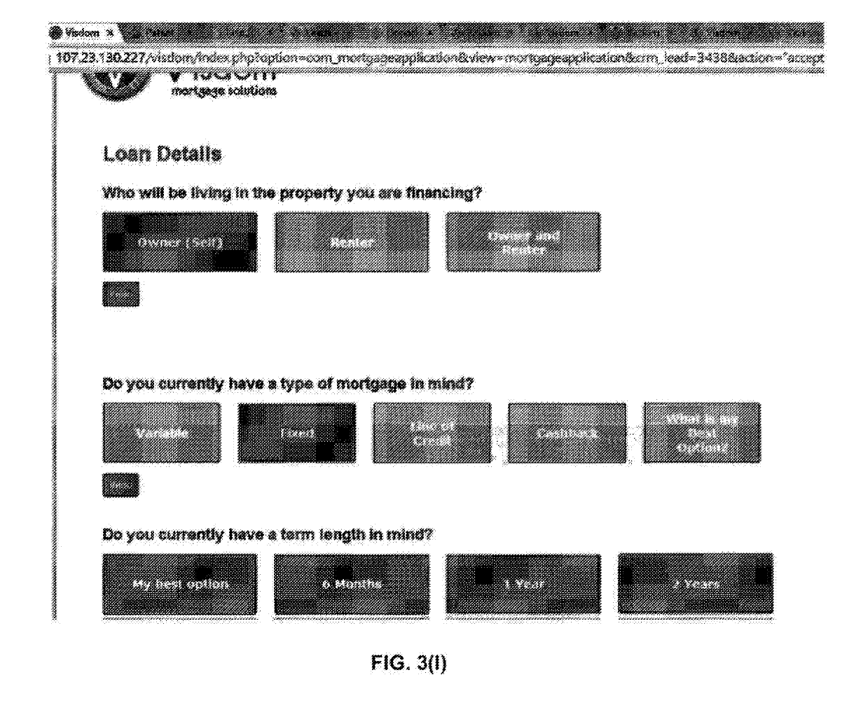

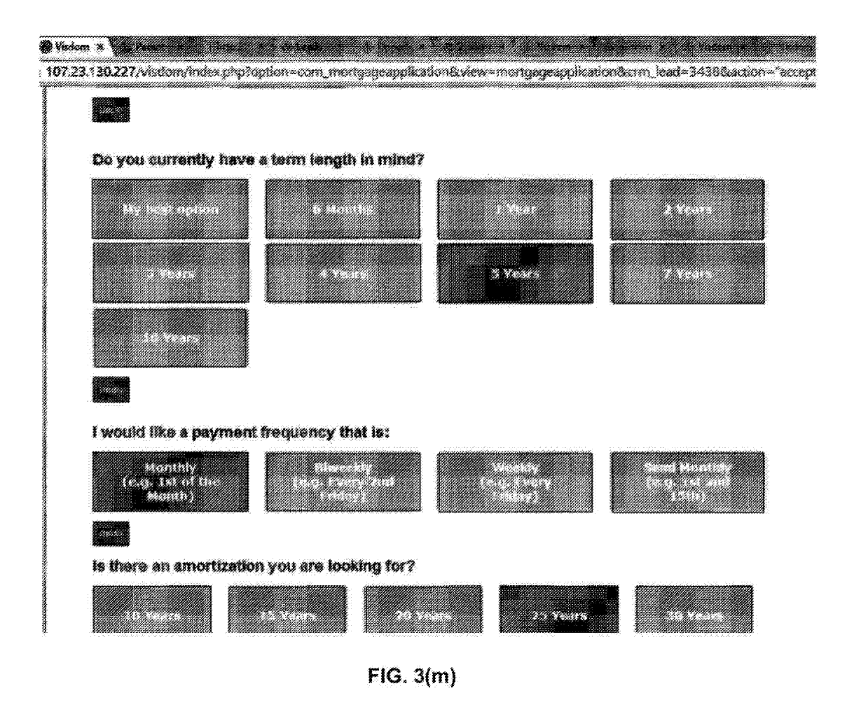

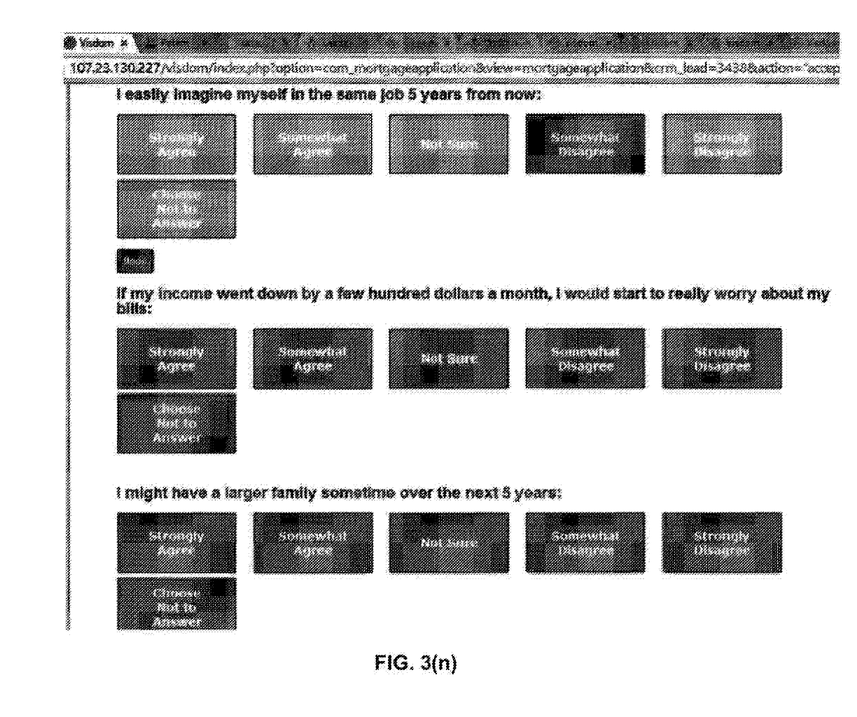

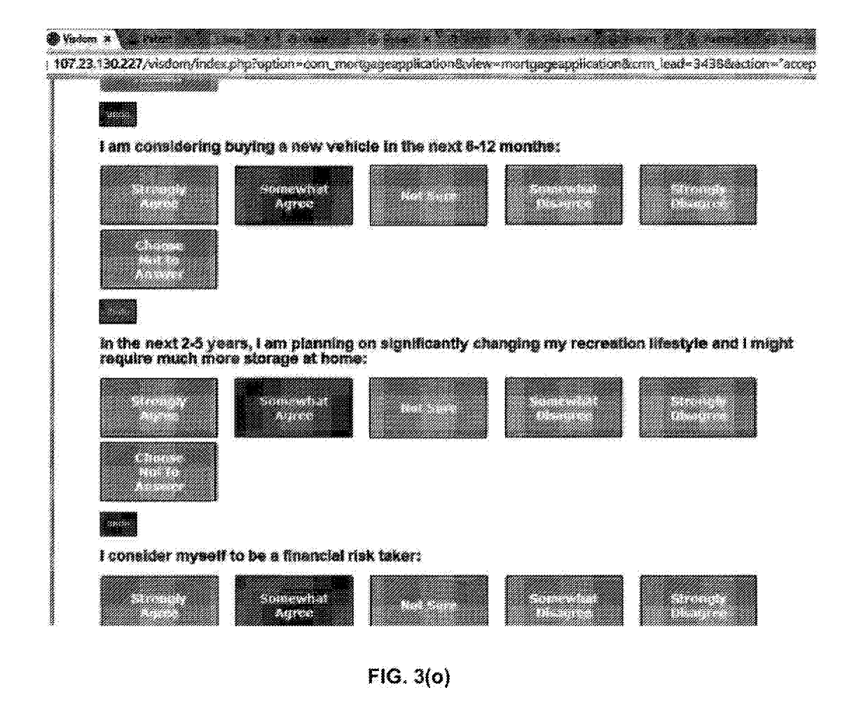

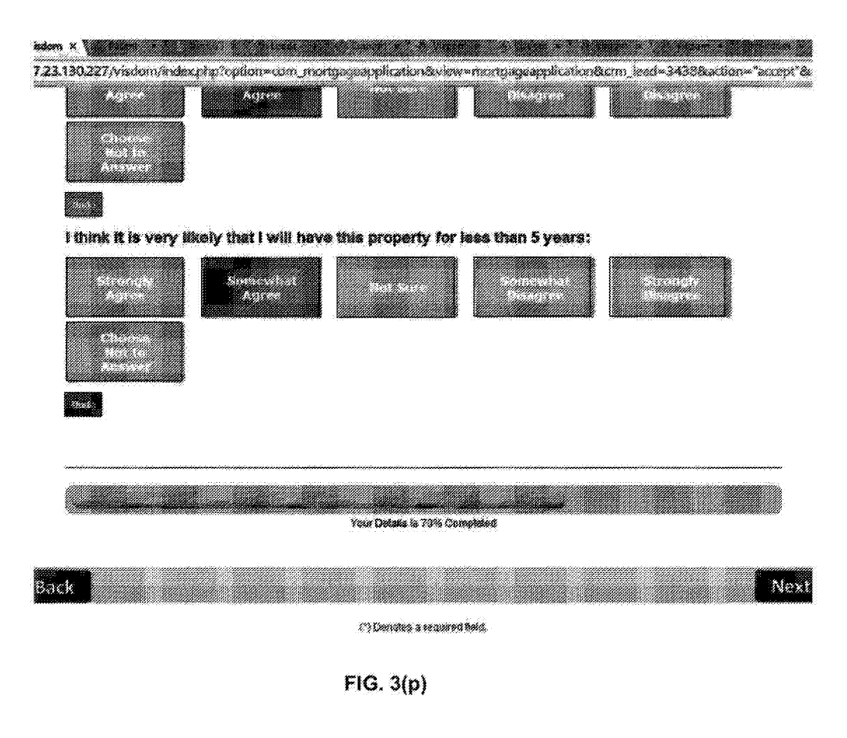

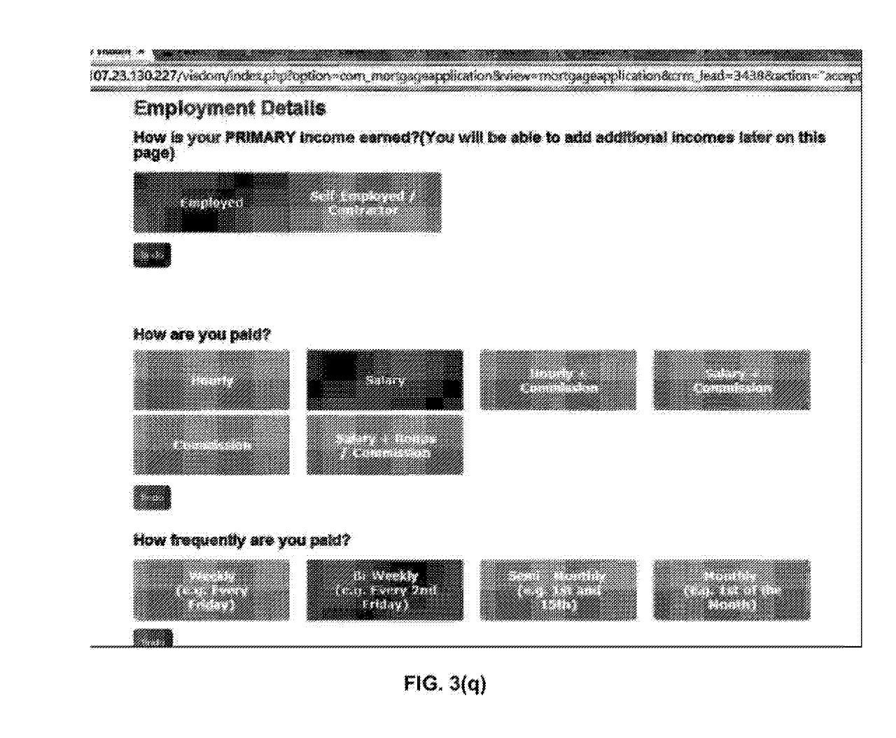

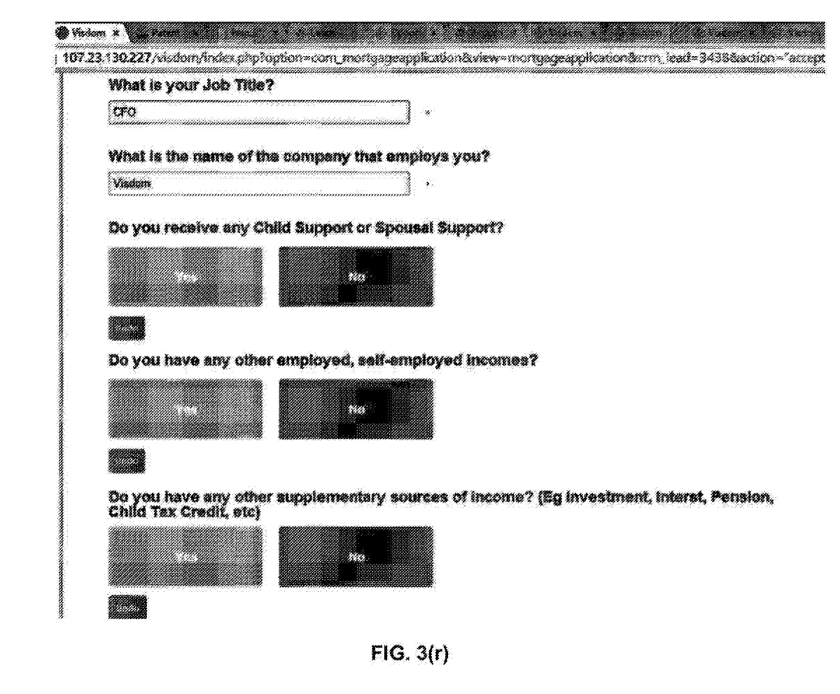

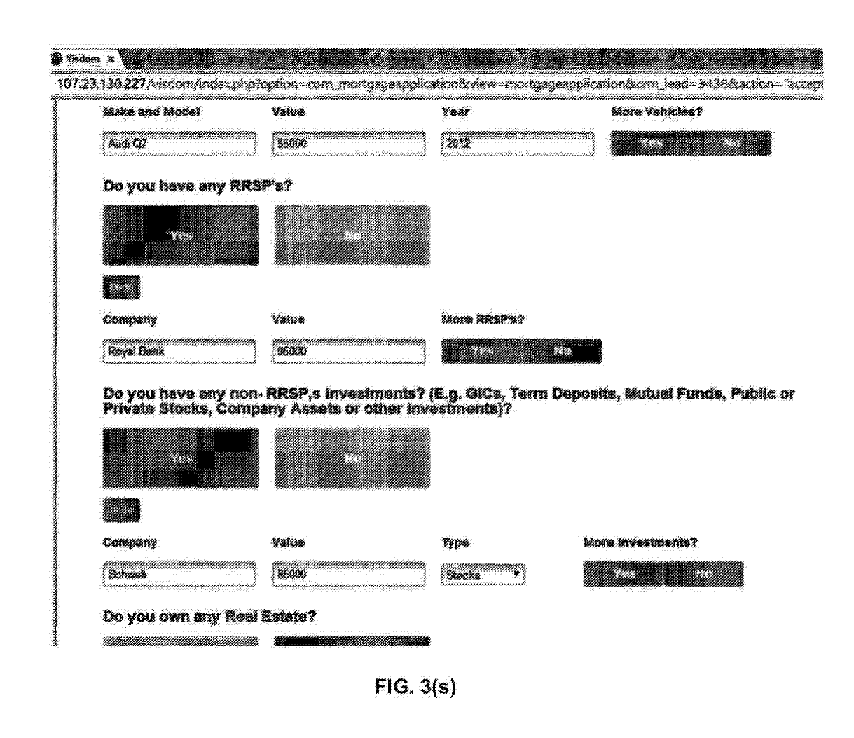

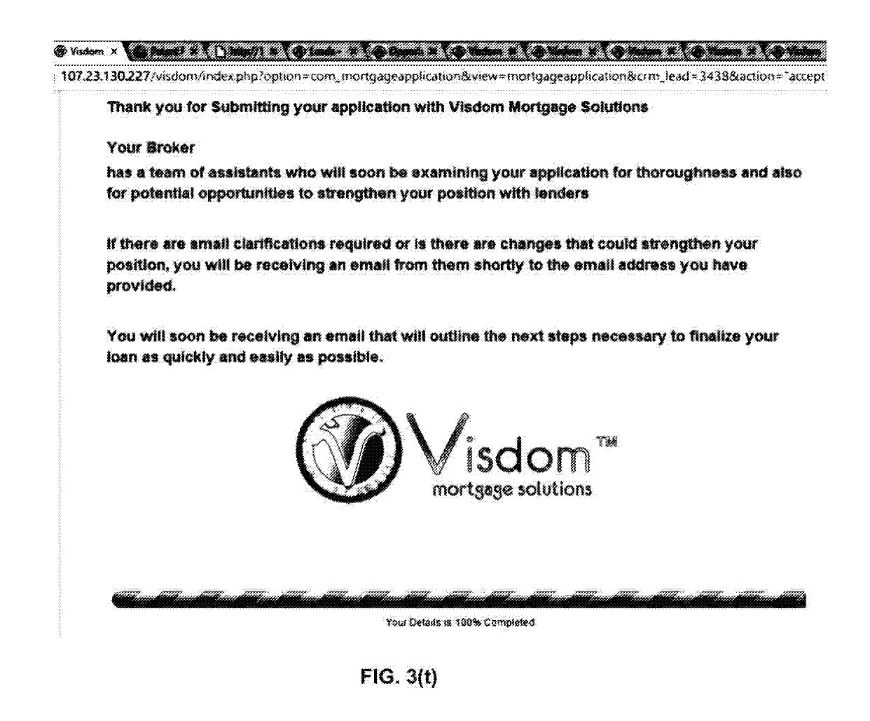

Exemplary embodiments of the Adaptive Finance Application 4 are shown in FIGS. 3(a) to 3(t). The Adaptive Finance Application 4 may be a secure online web application. Some embodiments of this Adaptive Finance Application 4 gather, for example, information related to the client and the client's goals necessary to underwrite their situation across thousands (and, potentially, hundreds of thousands) of loan products offered by hundreds (or thousands) of lending institutions. As a client enters information into the web application, the “question path” he needs to answer forms ahead of him to facilitate successful completion of primary goals. Exemplary examples of this question path include but are not limited to collecting information sufficient to understand the client's goals and to effectively underwrite their situation across a plurality of loan products from multiple lending institutions, and saving the client as much time and effort as possible by asking only the questions relevant to their situation and goals.

In addition to the “adaptability” of the Adaptive Finance Application to the client's situation (the way that the future web application path changes depending on the client's answers), other embodiments of this web application could have additional features. Exemplary embodiments include asking the client “suitability” and/or “lifestyle” questions. The concept of “suitability” has been developed by the investment industry to help ensure the investments a client owns “match” the client's “balance of goals” between preserving capital and gaining a return on investment. However, the finance industry presently has no such concept. In effect, all sorts of loan products are sold to a client that poorly match the client's goals of balancing between reducing interest costs and reducing future interest rate risk. This often results in increased costs or payout penalties to the client. Embodiments of the Adaptive Finance Application ask a number of questions that allow the assessment of that individual client's “risk profile” related to financing decisions rather than investment decisions. This “cost/risk reduction profile” is described below in further detail in the Multi-Lender Algorithmic Underwriting Application section.

Other additional features in the Adaptive Finance Application 4 may include “visual pick list” questions. Currently, many online applications (including, for example, mortgage and finance applications) involve fields which are pick lists. The user clicks an arrow in the box and a list of potential answers is presented. The user then clicks a second time to select the most appropriate answer. In exemplary embodiments, the Adaptive Finance Application includes a “visual pick list” for questions in which optional answers are presented as its own separate answer “button”. All potential answers to the question may be presented visually at once without having to click a dropdown arrow. The selected button becomes the “pick list selection” once that button is clicked. From a user experience perspective, this methodology is advantageous as it allows for easier navigation of the application on, for example, a tablet or a touchscreen device, and it also makes the experience faster.

B) CRM Integration

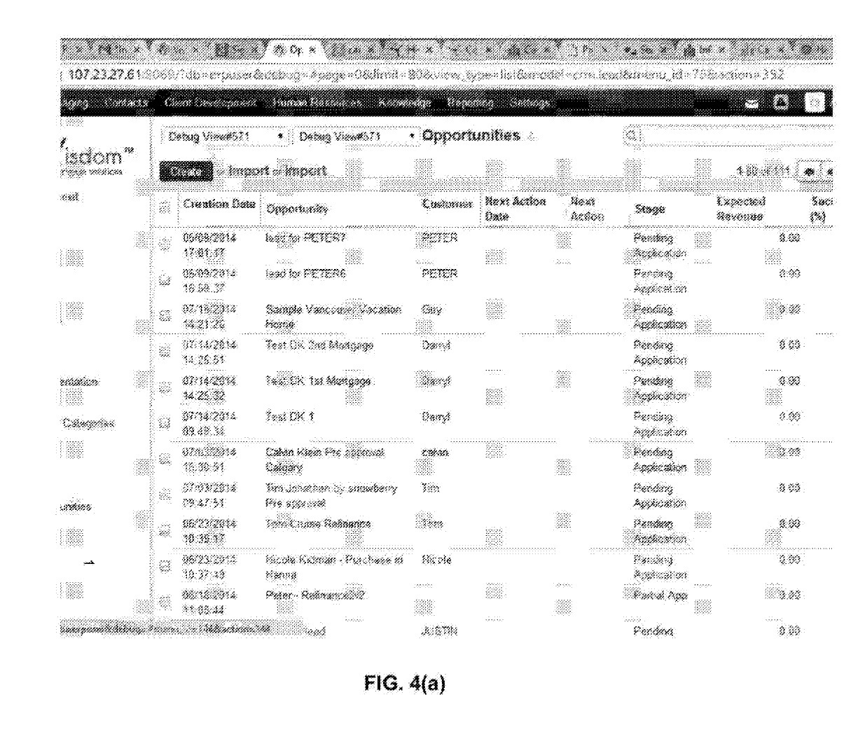

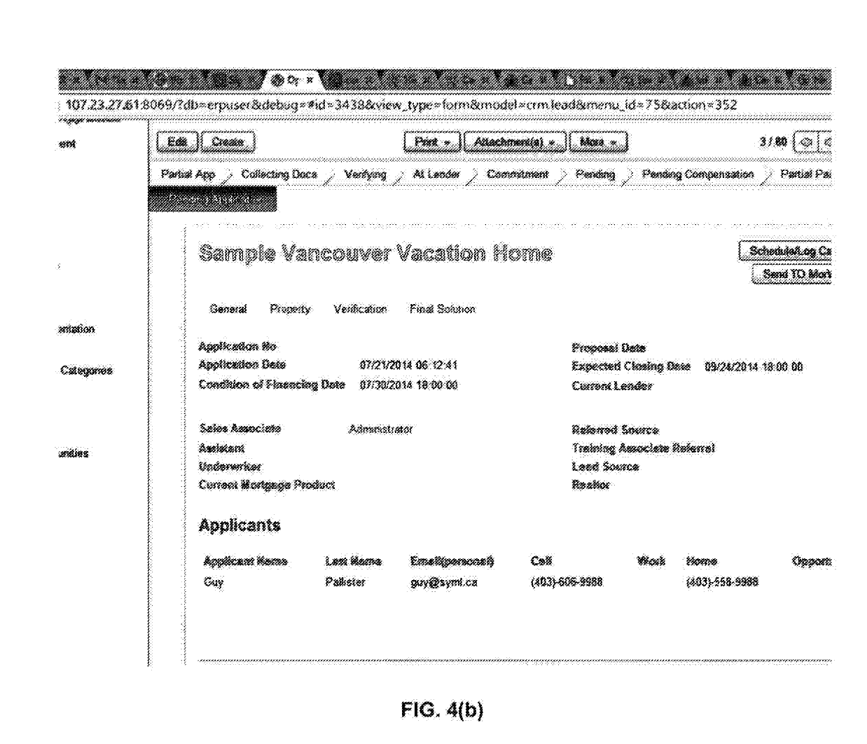

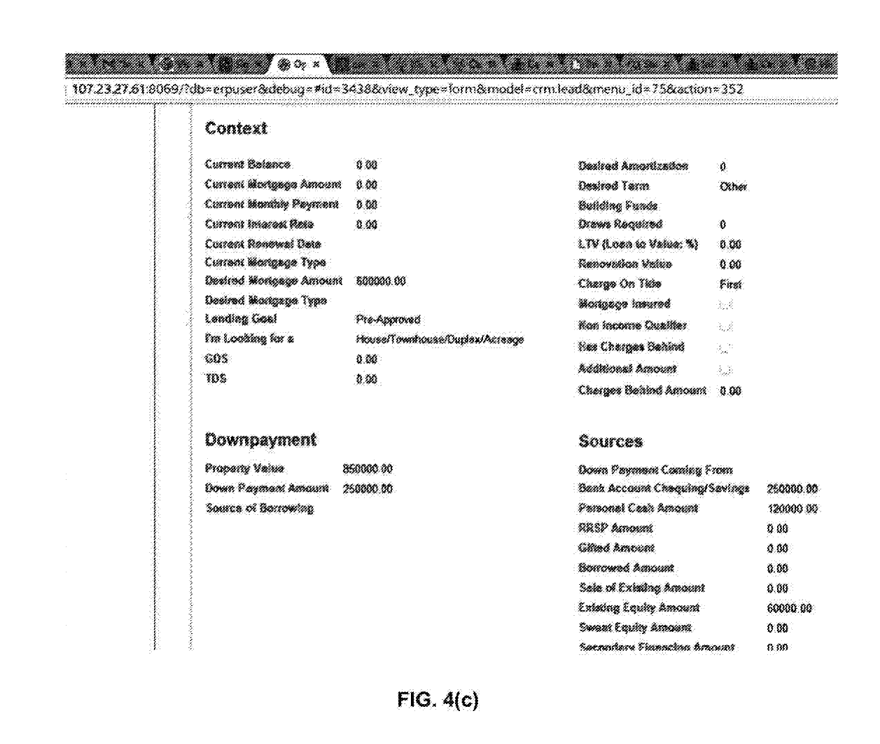

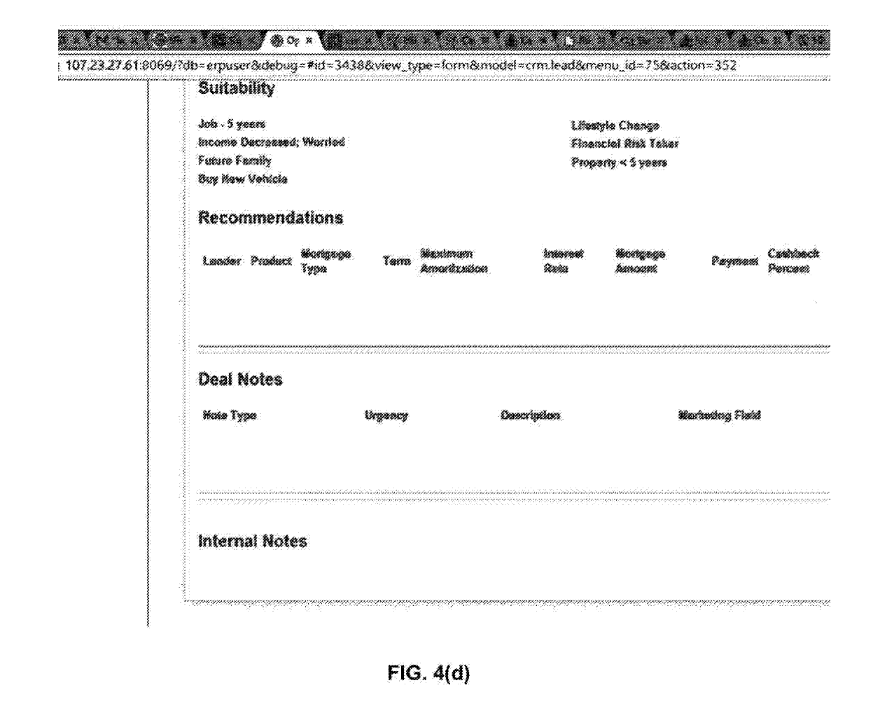

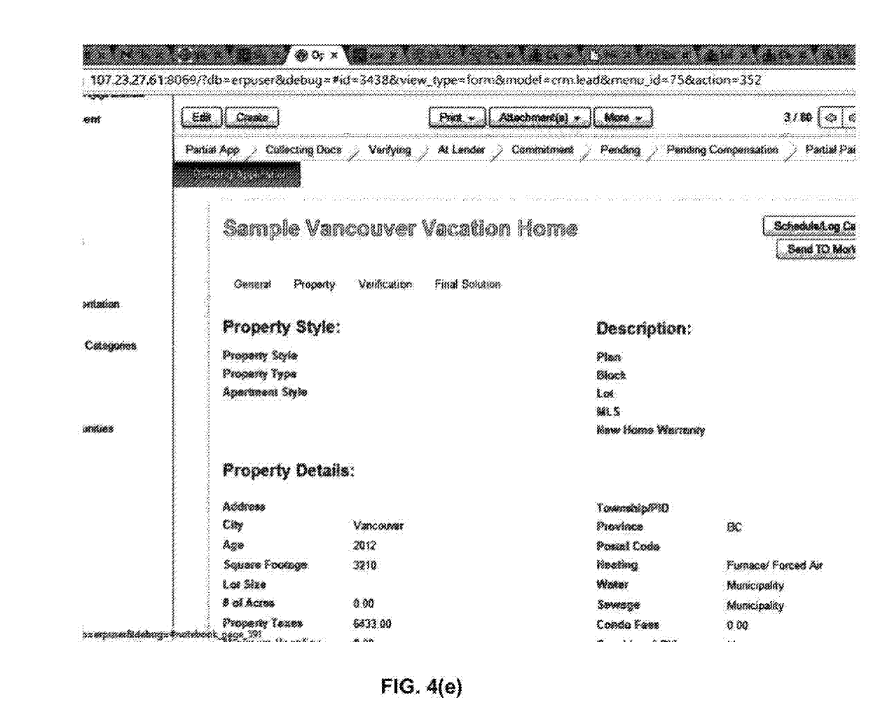

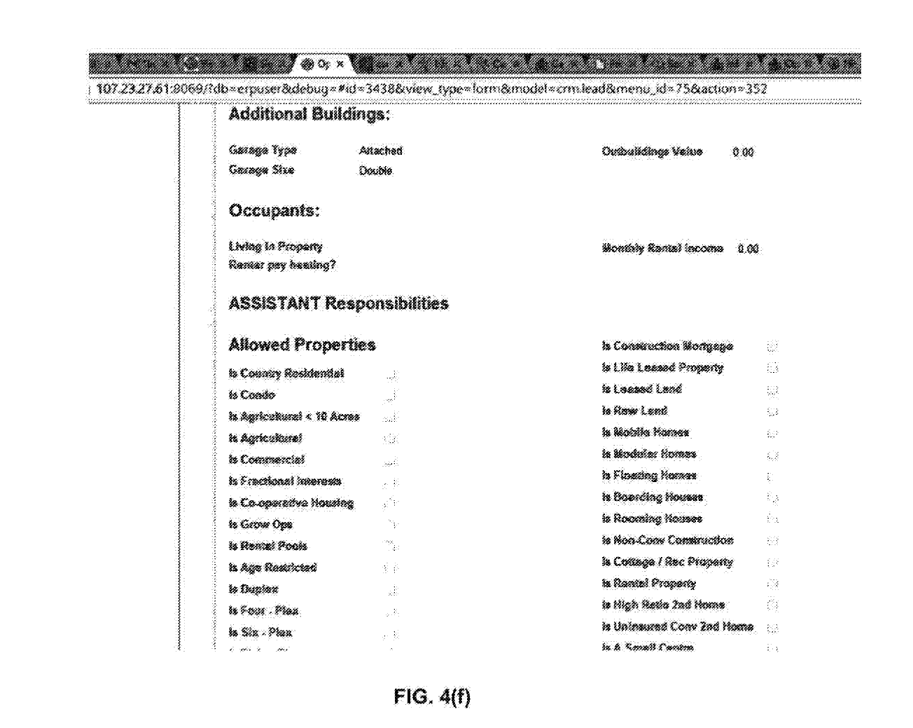

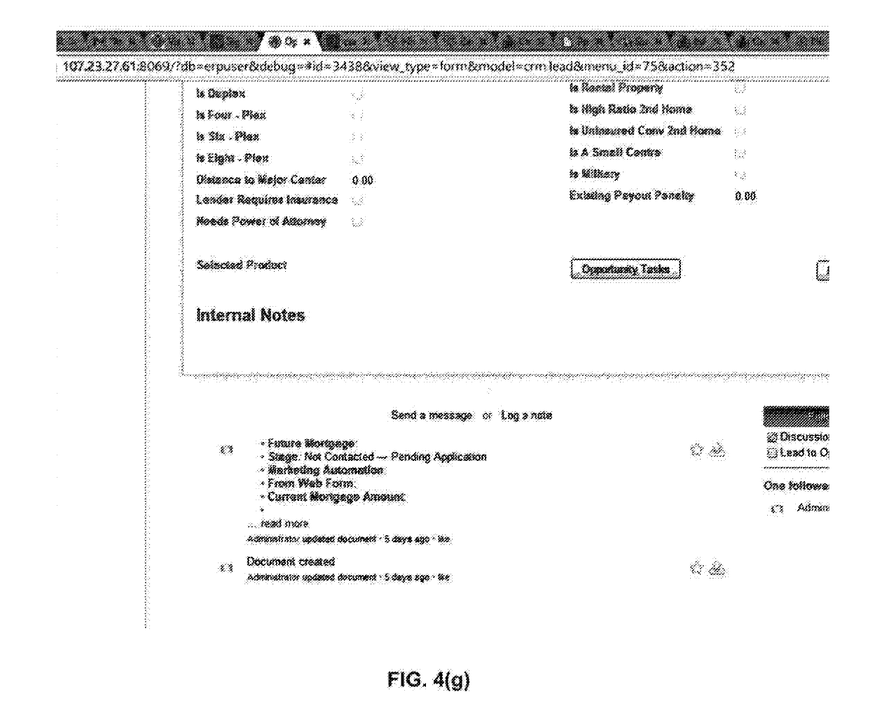

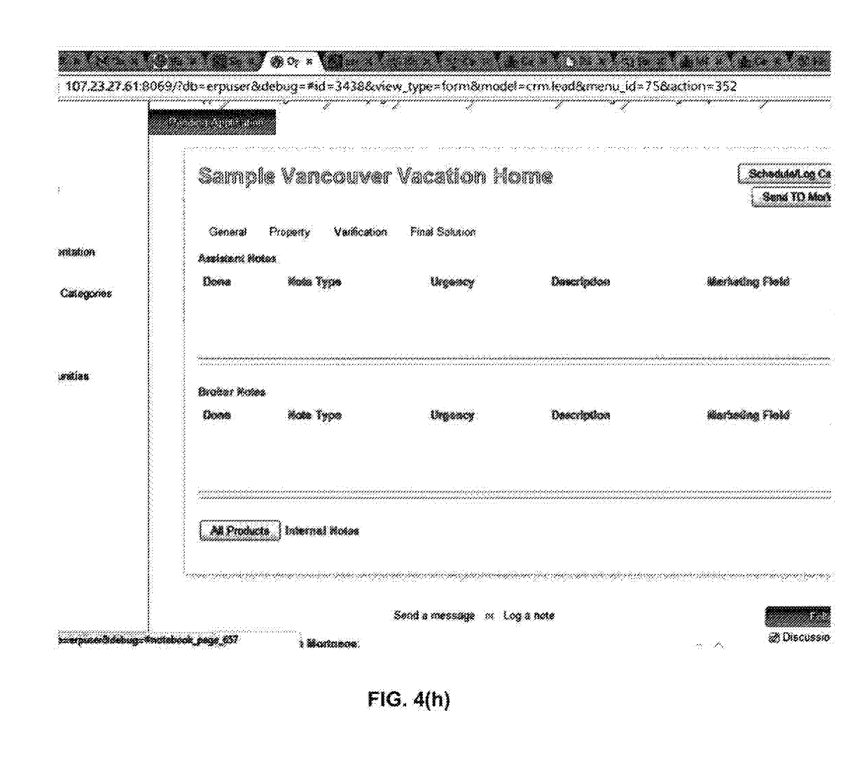

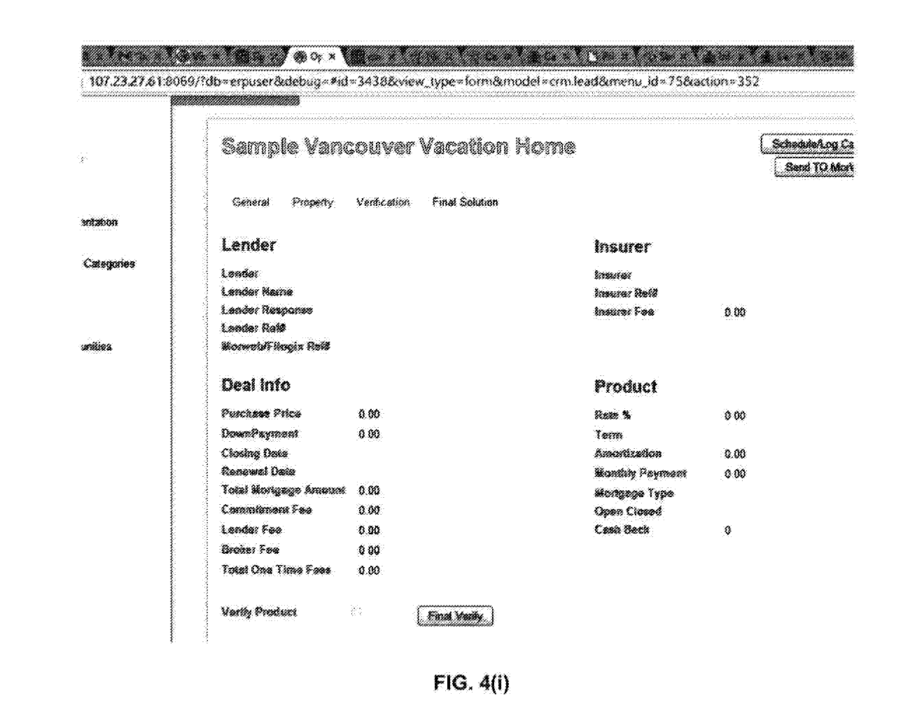

Exemplary embodiments of the CRM Integration (CRM module 5) are shown in FIGS. 4(a) to 4(i). The client's information and goals may be sent from the Adaptive Finance Application to a CRM platform. An integrated CRM platform (which may be an open source CRM platform) may be used to capture and manage communications and information (and reporting) related to a client. Additionally, some embodiments may have integrated third party middleware for the supplying of client credit information from various credit agencies (e.g., Equifax, TransUnion). The CRM platform can serve as a convenient, centralized place to manage the client's finance application.

C) Multi-Lender Algorithmic Underwriting Application

In various embodiments, the Multi-Lender Algorithmic Underwriting Application (underwriting module 6) can be a scalable, cloud-based application that underwrites the client's situation across thousands (and, potentially, hundreds of thousands) of potential finance products. The Underwriting Application may be comprised of a database of lenders and products, a communication layer to the CRM platform, and a logic layer (which may or may not have a user interface). It achieves this outcome through a series of staged communications with the CRM platform. For example, as a broker or assistant processes the client's application in the CRM platform, a number of communications may be sent from the CRM platform to the server running the Underwriting Application. The following paragraphs detail example communications and outcomes of the communication:

1) Verification Tasks—In order to prevent fraud, lenders require verification of key information related to the income and assets of the clients/applicants as well as the property being borrowed against. In some embodiments, the CRM platform initiates a communication to the Underwriting Application which contains the client's application. The Underwriting Application virtually underwrites the client's application across “an average” of lender requirements to determine the likely list of “verification tasks” which the broker's assistant will need to complete prior to underwriting the application across all potential products. The “custom task list” is sent from the Underwriting Application back to the CRM platform where it is received and automatically creates the appropriate tasks for the assistant (which may be quite a few tasks) and for the broker (which may be fewer tasks). In various embodiments, depending on the business model of a given distribution channel, these tasks could be automated into emails or texts from the CRM system to the client. In an embodiment, the tasks can be left in a list for the assistant to accomplish though a number of email communication templates, which have been built into the CRM platform.

2) All Products Underwriting—In exemplary embodiments, once the assistant or broker has verified the items required (e.g., for a mortgage, the income, assets, property taxes, etc., must be verified), the All Products Underwriting stage is triggered. The client application is re-sent to the Algorithmic Underwriting Application. The application then underwrites the client's situation across the thousands of products in its database. The products that “fail approval” may be logged with the reasons for failure for later data-mining and analysis. The products that “pass approval” can then each “scored” based upon a number of criteria including but not limited to cost-effectiveness, interest rate, flexibility, payout penalty considerations, ease of business, speed, cash-back features, and compensation to brokerage. The passed products are grouped by Mortgage Type and Term, and each grouping is sorted such that only the best product in each group is returned in a list of “recommendations” to the CRM platform. All products including those which are not at the top of the list may be logged for later potential data-mining and analysis. The final, for example, 5-20 products that make it into the “Recommendations List” are then “profiled” algorithmically to determine that specific product's cost/risk “suitability”.

Items involved in determining the product's “suitability” may include current cost (interest rate), future cost risk related to rising interest rates, future cost risk related to payout penalties, and opportunity cost risk related to falling interest rates. The single product whose “suitability” (which may be based on the factors listed above or on other related factors) most closely matches the client's “savings/risk profile” related to finance decisions (which may be determined by the suitability and lifestyle questions originally asked in the Adaptive Finance Application) is returned as the foremost and/or final “recommended” product and/or mortgage. The CRM platform receives a communication which contains the list of top Recommendations (which can be at least one from each product category), the foremost and/or final recommendation, and a custom generated paragraph of text (or other form of explanation) that explains the final recommendation and reasons for that recommendation.

3) Lender Packaging—In various embodiments, once the client has selected the product he wants (additional details in the “Multi-Lender Finance Summary” section below), the CRM platform may send the client's finalized application and the selected product to the Algorithmic Underwriting Application. The selected product can then be processed through an algorithm which checks potential fraud flags and also generates a list of “considerations” that are specific to that lender's underwriting requirements. This list of “considerations” highlights the key underwriting criteria and specifies how the client and property conforms to the lender's criteria. In the event that there are any irregularities which are within the lender's “tolerance level” for “exceptions”, these exceptions may be pointed out and the rationale for acceptance despite the exceptions may be provided.

4) Finalization—According to various embodiments, once the lender has provided the offer for the client and the client has approved it, the CRM platform may then send a finalization communication which calculates all compensation related information for securing the financing as well as finalized “solution details” related to the client and the property, and returns this information to the CRM platform for storage and/or future reference.

5) Ongoing Financing Evaluation (ongoing evaluation module 7)—Periodically, for example, on every three month anniversary of the completed financing, the CRM platform may send the completed financing to the Underwriting Application. In some embodiments, the Underwriting application “re-underwrites” the client's goals across all products which are currently in the marketplace (considering, for example, payout penalties and changes in property values) to determine whether the client is potentially able to either save money or access additional capital. In exemplary embodiments in which the results of this “ongoing re-underwriting” are positive, a summary of client's opportunity can be sent back to the CRM platform as a task to the broker to contact the client to inform him of their opportunity. In this example, the client's financing is being regularly reviewed to ensure it is still optimal. Conversely, in another example, if the client's financing is not optimal, the client is presented with the opportunity to revise.

In one embodiment, the CRM platform is utilized as the interface to revise products in the Underwriting Database. In another embodiment, an interface directly coupled to the Underwriting Application can be used for the managing of lender and product information and underwriting criteria. Other embodiments can include a portal that, for example, allows lenders to manage key portions of the details and underwriting criteria related to their own products as well as an API which could allow lenders to manage their key product criteria automatically as they make changes in their own systems (if, for example, they have decided to integrate their products into the system).

D) Finance Summary

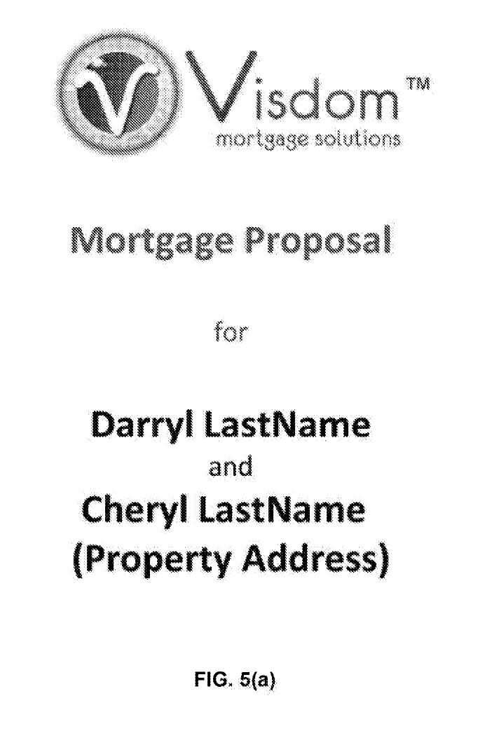

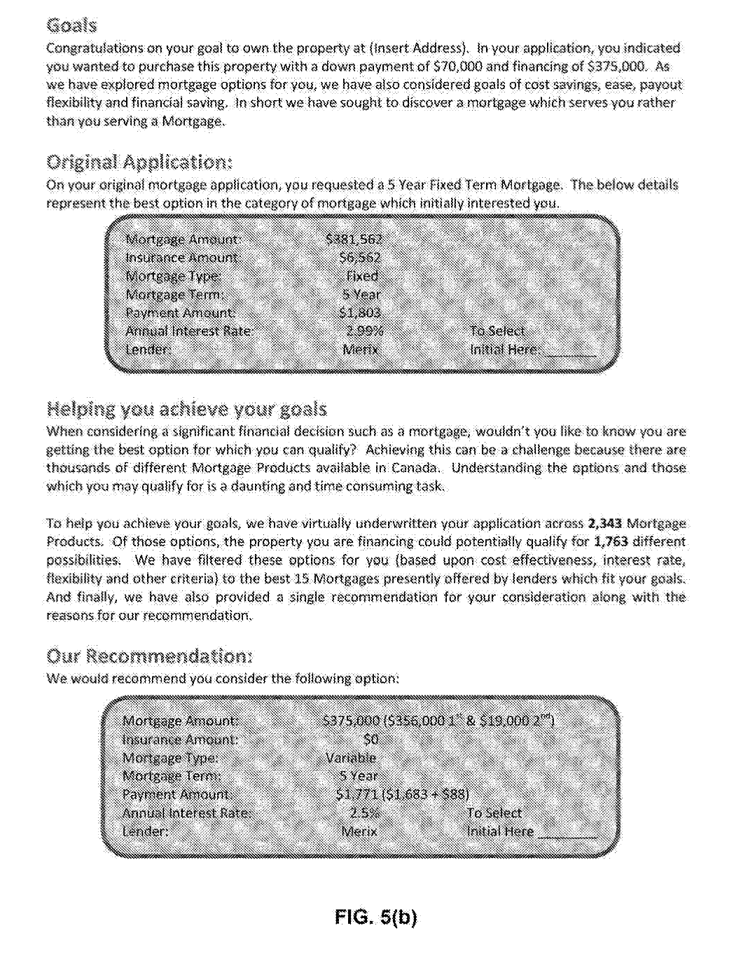

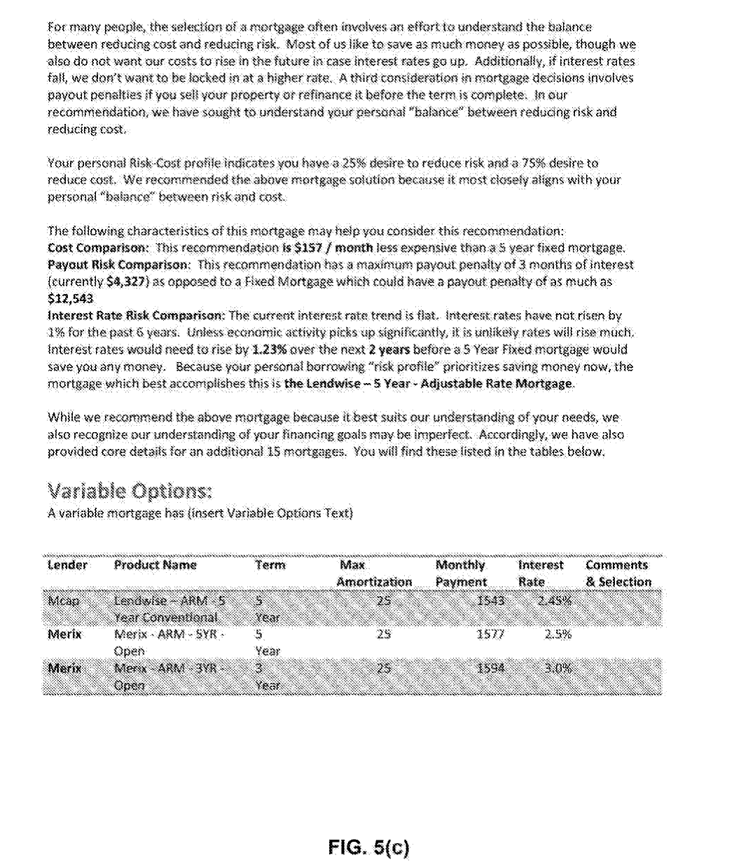

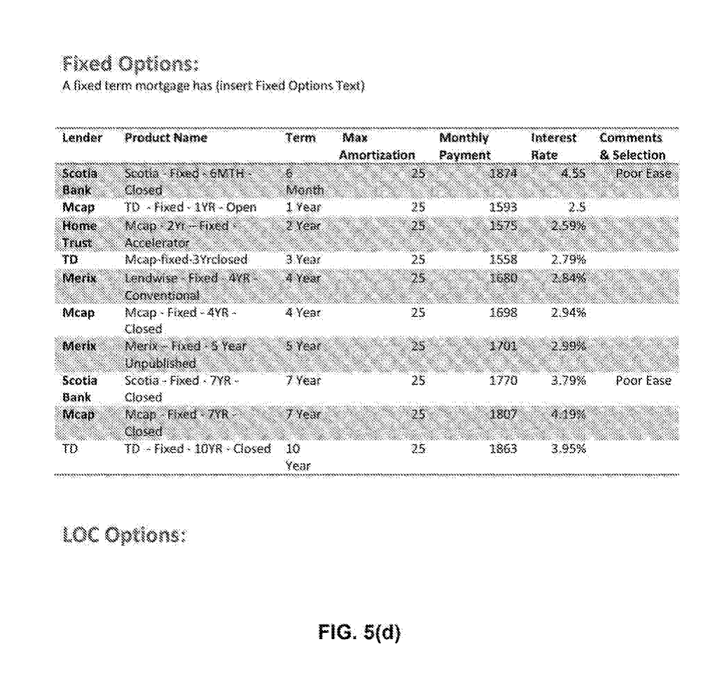

Exemplary embodiments of the Finance Summary are shown in FIGS. 5(a) to 5(d). Once the All Products Underwriting stage of the Underwriting Application has run, the client may be presented with a “Proposal” or “Summary” of the “Best Recommendations” that were returned by the Algorithmic Underwriting Application. In one embodiment, this summary can be presented in a password protected Webpage.

According to some embodiments, the present technology is implemented as a server or in a cloud-computing environment. The server is provided with a processor and a memory for storing instructions. The memory includes the various algorithms, applications, and modules referenced above. The processor executes the instructions to perform the methods specified above. An example processor and memory are described below with reference to FIG. 1.

In one embodiment, the server is configured to receive underwriting requirements from a plurality of lenders systems. The lender systems can update their underwriting requirements and provide the updated requirements to the server on an as-needed basis so that the server is provided individuals with the most recent and up to date underwriting services.

Underwriting requirements are used to determine whether a potential mortgagee is eligible for one or more loans provided by a lender. The underwriting algorithm may include a variety of thresholds for various underwriting categories. For example, the underwriting algorithm can comprise credit score thresholds or ranges. Lenders will typically have products within various credit score ranges. The underwriting algorithm may also comprise information for lenders that provide loans to self-employed individuals. In other examples, the underwriting requirements can include thresholds for down payment amount, escrow requirements, closing costs, and other similar costs and fees.

Correspondingly, the server adaptively obtains financial information for the individual. In one example, the server may determine that the individual is only interested in loans that can be obtained with a small to no down payment. The server will adapt the remaining questions of the inquiry such that the individual is not asked questions about products for which the individual will not qualify. For example, the server will not ask questions that would potentially qualify the individual for a jumbo loan, because such loans require large down payments.

In another example, the server may determine that the individual is planning on living in the subject property until retirement and the individual has answered questions that indicate that the individual is highly risk adverse, so the server will not ask questions that would be required to qualify the individual for a short term ARM or adjustable rate loan.

Again, the adaptability of the loan inquiry process will be guided by first obtaining a baseline set of information about the individual's financial position and risk tolerance. Additional questions can be asked only when this baseline information is ascertained. Baseline financial information can include yearly income, work history, and so forth. Baseline risk information can be obtained by posing risk inducing scenarios to the individual and/or asking the individual about their overall financial goals and risk profile. Again, in some instances, baseline financial information can cause the server to adapt the risk analysis portion of the loan inquiry. Conversely, baseline risk information can cause the server to adapt the financial analysis portion of the loan inquiry.

The adaptive path of the loan inquiry process is at least partially determined by the underwriting requirements received from the lenders. As mentioned above, the loan inquiry should include enough questions so that sufficient information about the individual is obtained. Thus, the individual can be suitably matched by comparing the information obtained from the user against the underwriting requirements of various loans.

In some embodiments, a method executed by the server comprises a step of receiving underwriting requirements from a plurality of lenders. Also, the method includes the server generating an adaptive finance application using the underwriting requirements. In some embodiments, the adaptive finance application is configured to provide a loan applicant with a set of questions designed to elicit responses that are indicative of financial and risk attributes for the loan applicant.

In some embodiments, content of each successive question of the set of questions depends upon prior responses to previous questions. Again, with the examples above, the responses of the loan applicant are used to direct the creation of questions. The end purpose of the questions is to elicit enough information that the loan applicant can be underwritten for a plurality of loans.

Next, the method includes the server executing a multi-lender algorithmic underwriting application that compares the responses of the loan applicant to the underwriting requirements of the plurality of lenders.

Finally, the method includes the server generating a finance summary that includes loans matched to the responses of the loan applicant.

Thus, in an aspect, there is provided a computer-implemented system for online evaluation and underwriting of loan products, the system having at least one processor and a memory and comprising: an adaptive finance application for posing questions designed to elicit responses indicative of financial and risk attributes for the client, wherein the content of each successive question of the set of questions depends upon prior responses to previous questions, such that a detailed client profile is generated from the responses; a multi-lender algorithmic underwriting application for comparing matching criteria derived from the detailed client profile against a database of loan products with underwriting requirements available from multiple lending institutions, and identifying loan products matching the detailed client profile; and an output for outputting loan products with underwriting requirements having a close match to the detailed client profile.

In an embodiment, the adaptive finance application is configured to generate a detailed client profile including financial information, risk preferences, and short-term and longer term goals.

In another embodiment, the adaptive finance application is further configured to periodically review the responses indicative of financial and risk attributes for the client, and to modify the content of each successive question of the set of questions if responses change, such that an updated detailed client profile is generated.

In another embodiment, the multi-lender algorithmic underwriting application is configured to periodically run the updated client profile against an updated database of loan products with underwriting requirements available from multiple lending institutions, and identifying loan products matching the updated detailed client profile.

In another embodiment, the system is further configured to output loan products with underwriting requirements having a close match to the updated detailed client profile.

In another embodiment, the output is configured to list the output loan products by the degree to which the loan products match the detailed client profile.

In another embodiment, the multi-lender algorithmic underwriting application is configured to generate a recommendation for utilizing multiple blended loan products at the same time, based on optimization of at least one criteria derived from the detailed client profile.

In another embodiment, the adaptive finance application and multi-lender algorithmic underwriting application are configured to generate alternative “what-if” scenarios, if the client selects one loan product over another, or changes a key parameter in the detailed client profile.

In another embodiment, the adaptive finance application and multi-lender algorithmic underwriting application are configured to periodically update the detailed client profile and rerun the match against an updated database of loan products with underwriting requirements available from multiple lending institutions.

In another aspect, there is provided a computer-implemented method of online evaluation and underwriting of loan products, the method comprising: providing an adaptive finance application for posing questions designed to elicit responses indicative of financial and risk attributes for the client, wherein the content of each successive question of the set of questions depends upon prior responses to previous questions, such that a detailed client profile is generated from the responses; providing a multi-lender algorithmic underwriting application for comparing matching criteria derived from the detailed client profile against a database of loan products with underwriting requirements available from multiple lending institutions, and identifying loan products matching the detailed client profile; and outputting loan products with underwriting requirements having a close match to the detailed client profile.

In an embodiment, the method further comprises configuring the finance application to generate a detailed client profile including financial information, risk preferences, and short-term and longer term goals.

In an embodiment, the method further comprises configuring the adaptive finance application to periodically review the responses indicative of financial and risk attributes for the client, and to modify the content of each successive question of the set of questions if responses change, such that an updated detailed client profile is generated.

In an embodiment, the method further comprises configuring the multi-lender algorithmic underwriting application to periodically run the updated client profile against an updated database of loan products with underwriting requirements available from multiple lending institutions, and identifying loan products matching the updated detailed client profile.

In an embodiment, the method further comprises outputting loan products with underwriting requirements having a close match to the updated detailed client profile.

In an embodiment, the method further comprises listing the output loan products by the degree to which the loan products match the detailed client profile.

In an embodiment, the method further comprises configuring the multi-lender algorithmic underwriting application to generate a recommendation for utilizing multiple blended loan products at the same time, based on optimization of at least one criteria derived from the detailed client profile.

In an embodiment, the method further comprises configuring the adaptive finance application and multi-lender algorithmic underwriting application to generate alternative “what-if” scenarios, if the client selects one loan product over another, or changes a key parameter in the detailed client profile.

In an embodiment, the method further comprises configuring the adaptive finance application and multi-lender algorithmic underwriting application to periodically update the detailed client profile and rerun the match against an updated database of loan products with underwriting requirements available from multiple lending institutions.

In another aspect, there is provided a non-transitory computer-readable medium storing computer executable code for online evaluation and underwriting of loan products, the computer-readable medium comprising: code for executing an adaptive finance application for posing questions designed to elicit responses indicative of financial and risk attributes for the client, wherein the content of each successive question of the set of questions depends upon prior responses to previous questions, such that a detailed client profile is generated from the responses; code for executing a multi-lender algorithmic underwriting application for comparing matching criteria derived from the detailed client profile against a database of loan products with underwriting requirements available from multiple lending institutions, and identifying loan products matching the detailed client profile; and code for outputting loan products with underwriting requirements having a close match to the detailed client profile.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A computer-implemented system for online evaluation and underwriting of loan products, said system comprising:
a memory storing therein a database of loan products;
a graphics display system;
a client input device;
a network interface for communication over a network; and
at least one processor functionally coupled to the memory, the graphics display system, the client input device, and the network interface;
wherein the at least one processor is configured for executing computer-executable code of an adaptive finance application for (a) adaptively displaying a set of questions related to the financial and risk attributes of a client, (b) receiving client inputs responsive to the displayed set of questions, (c) generating a client profile based on received client inputs, and (d) periodically updating the client profile based on received client inputs;
wherein the at least one processor is also configured for executing computer-executable code of a multi-lender algorithmic underwriting application for:
(1) virtually underwriting loan products across an average of lender requirements to determine a list of verification tasks;
(2) comparing matching criteria derived from the client profile against a database of loan products stored in a memory with underwriting requirements available from multiple lending institutions;
(3) identifying loan products matching the client profile;
(4) selecting, from the identified loan products, the loan products with underwriting requirements having a close match to the client profile; and
(5) outputting the selected loan products; and
wherein the computer-executable code for adaptively displaying the set of questions comprises computer-executable code for:
(i) selecting one or more questions from the set of questions based on the client profile and at least one of the previously received client inputs; and
(ii) displaying on the graphics display system the selected one or more questions.

2. The computer-implemented system of claim 1, wherein the client profile comprises at least financial information, risk preferences, and short-term and longer term goals.

3. The computer-implemented system of claim 1, wherein the at least one processor is configured for further executing computer-executable code of the multi-lender algorithmic underwriting application for (5) for each identified loan product, determining a degree to which the client profile matches the loan product and their underwriting requirements; (6) ranking the identified loan products based on the degree, and (7) generating a report to recommend the closest match.

4. The computer-implemented system of claim 3, wherein said step (2) of identifying loan products matching the client profile comprises identifying loan products that pass approval;
wherein said step (5) of determining a degree comprises determining a score based upon a plurality of criteria at least including cost-effectiveness, interest rate, flexibility, payout penalty considerations, speed, cash-back features, and compensation to brokerage; and
wherein said step (6) of ranking the identified loan products based on the degree comprises (6a) grouping the identifying loan products, and (6b) sorting the identifying loan products in each group.

5. The computer-implemented system of claim 1, wherein the at least one processor is configured for further executing the computer-executable code of the adaptive finance application for periodically reviewing the client inputs indicative of financial and risk attributes for the client, and modifying the content of each question of the set of questions if the client inputs change, such that an updated client profile is generated.

6. The computer-implemented system of claim 5, wherein the computer-executable code of the multi-lender algorithmic underwriting application further comprises computer-executable code for periodically running the updated client profile against an updated database of loan products with underwriting requirements available from multiple lending institutions, for identifying loan products matching the updated client profile, and for selecting, from the identified loan products, the loan products with underwriting requirements having a close match to the updated client profile.

7. The computer-implemented system of claim 6, wherein the at least one processor further executes computer-executable code for outputting the selected loan products.

8. The computer-implemented system of claim 1, wherein the computer-executable code for outputting the selected load products comprises computer-executable code for listing the selected loan products by the degree to which the selected loan products match the client profile.

9. The computer-implemented system of claim 1, wherein the at least one processor further executes computer-executable code of the multi-lender algorithmic underwriting application for generating a recommendation for utilizing multiple blended loan products at the same time, based on optimization of at least one criteria derived from the client profile.

10. The computer-implemented system of claim 1, wherein the at least one processor further executes computer-executable code for generating alternative “what-if” scenarios, if the client inputs select one loan product over another, or change a key parameter in the client profile.

11. The computer-implemented system of claim 10, wherein the at least one processor further executes computer-executable code for periodically updating the client profile and rerunning the match against an updated database of loan products with underwriting requirements available from multiple lending institutions.

12. The computer-implemented system of claim 1, wherein at least one question of the set of questions comprises a plurality of user selectable options; and wherein, when displaying said question, the at least one processor executes computer-executable code for displaying the plurality of user selectable options in a matrix arrangement with each user selectable option being displayed as a user selectable button.

13. A computer implemented method of online evaluation and underwriting of loan products, the method comprising:
adaptively displaying a set of questions related to the financial and risk attributes of a client;
receiving client inputs responsive to the displayed set of questions;
generating a client profile based on received client inputs;
periodically updating the client profile based on received client inputs; and
executing a multi-lender algorithmic underwriting application for:
(1) virtually underwriting loan products across an average of lender requirements to determine a list of verification tasks;
(2) comparing matching criteria derived from the client profile against a database of loan products stored in a memory with underwriting requirements available from multiple lending institutions;
(3) identifying loan products matching the client profile;
(4) selecting, from the identified loan products, the loan products with underwriting requirements having a close match to the client profile; and
(5) outputting the selected loan products;
wherein said adaptively displaying the set of questions comprises:
(i) selecting one or more questions from the set of questions based on the client profile and at least one of the previously received client inputs; and
(ii) displaying on a graphics display system the selected one or more questions.

14. The computer-implemented method of claim 13 further comprising periodically reviewing the client inputs indicative of financial and risk attributes for the client, and modifying the content of each question of the set of questions if client inputs change, such that an updated client profile is generated.

15. The computer-implemented method of claim 14 further comprising periodically running the updated client profile against an updated database of loan products with underwriting requirements available from multiple lending institutions, identifying loan products matching the updated client profile, and selecting, from the identified loan products, the loan products with underwriting requirements having a close match to the updated client profile.

16. The computer-implemented method of claim 13 further comprising listing the selected loan products by the degree to which the selected loan products match the client profile.

17. The computer-implemented method of claim 13 further comprising generating a recommendation for utilizing multiple blended loan products at the same time, based on optimization of at least one criteria derived from the client profile.

18. The computer-implemented method of claim 13 further comprising generating alternative “what-if” scenarios, if the client inputs select one loan product over another, or change a key parameter in the client profile.

19. The computer-implemented method of claim 18 further comprising periodically updating the client profile and rerunning the match against an updated database of loan products with underwriting requirements available from multiple lending institutions.

20. A non-transitory computer-readable medium storing computer-executable code for online evaluation and underwriting of loan products, the computer-executable code, when executed by at least one processor, causing the at least one processor to perform actions comprising:
adaptively displaying a set of questions related to the financial and risk attributes of a client;
receiving client inputs responsive to the displayed set of questions;
generating a client profile based on received client inputs;
periodically updating the client profile based on received client inputs; and
executing a multi-lender algorithmic underwriting application for:
(1) virtually underwriting loan products across an average of lender requirements to determine a list of verification tasks;
(2) comparing matching criteria derived from the client profile against a database of loan products stored in a memory with underwriting requirements available from multiple lending institutions;
(3) identifying loan products matching the client profile;
(4) selecting, from the identified loan products, the loan products with underwriting requirements having a close match to the client profile; and
(5) outputting the selected loan products;
wherein said adaptively displaying the set of questions comprises:
(i) selecting one or more questions from the set of questions based on the client profile and at least one of the previously received client inputs; and
(ii) displaying on a graphics display system the selected one or more questions.
